(19) United States
(12) Patent Application Publication
(10) Pub. No.: US 2023/0053430 A1
(43) Pub. Date: Feb. 23, 2023

(54) METHODS FOR HANDLING SPECIAL RELATIONS FOR PUCCH RESOURCES BELONGING TO MULTIPLE PUCCH CONFIGURATIONS

(71) Applicant: TELEFONAKTIEBOLAGET LM ERICSSON (PUBL), Stockholm (SE)

(72) Inventors: Helka-Liina Määttänen, HELSINKI (FI); Zhenhua Zou, SOLNA (SE); Yufei Blankenship, KILDEER, IL (US); Mats Folke, VÄLLINGBY (SE)

(21) Appl. No.: 17/790,888

(22) PCT Filed: Dec. 15, 2020
(86) PCT No.: PCT/IB2020/061987

§ 371 Date: Jul. 5, 2022

Related U.S. Application Data
(60) Provisional application No. 62/972,429, filed on Feb. 10, 2020.

(51) Int. Cl. H04L 5/00; H04B 7/0404; H04B 7/08

(52) U.S. Cl. CPC H04L 5/0053; H04B 7/0404; H04B 7/088; H04L 5/0025; H04L 5/0091

(57) ABSTRACT

The present disclosure provides a method in a wireless device, for handling spatial relations for Physical Uplink Control Channel (PUCCH) resources belonging to different PUCCH groups or PUCCH resource configuration groups. The method comprises: receiving, from a network node, a command to activate or deactivate a spatial relation for a PUCCH resource, wherein each PUCCH of the different PUCCH groups is uniquely identified in the command; and performing one of activating and deactivating a spatial relation for the PUCCH resource identified in the command. A wireless device for implementing this method is also provided.

### RELATED APPLICATION

The application claims the benefits of priority of U.S. Provisional Patent Application No. 62/972,429, entitled “PUCCH Enhancements with Multiple PUCCH Configs” and filed at the United States Patent and Trademark Office on Feb. 10, 2020, the content of which is incorporated herein by reference.

### TECHNICAL FIELD

The present description generally relates to wireless communication systems and more specifically to enhance Physical Uplink Control Channel (PUCCH) handling in the context of multiple PUCCH configurations.

### BACKGROUND

### New Radio (NR) Frame Structure and Resource Grid

NR uses Cyclic Prefix Orthogonal Frequency Division Multiplexing (CP-OFDM) in both downlink (DL) (i.e. from a network node (e.g. gNB or base station) to a user equipment (UE)) and uplink (UL) (i.e. from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel, either physical downlink shared channel (PDSCH) or physical uplink shared channel (PUSCH). FIG. 1 illustrates a NR time-domain structure with 15 kHz subcarrier spacing.

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings is given by

$$\frac{1}{{2}^{μ}} m s .$$

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink transmissions are dynamically scheduled, i.e., in each slot the gNB transmits downlink control information (DCI) over Physical Downlink Control Channel (PDCCH) about which UE data is to be transmitted to and which RBs in the current downlink slot the data is transmitted on. The UE data are carried on PDSCH.

There are three DCI formats defined for scheduling PDSCH in NR, i.e., DCI format 1_0 and DCI format 1_1 which were introduced in NR Rel-15, and DCI format 1_2 which was introduced in NR Rel-16. Typically, DCI format 1_0 has a smaller size than DCI 1_1 and can be used when a UE is not fully connected to the network, while DCI format 1_1 can be used for scheduling Multiple-Input-Multiple-Output (MIMO) transmissions with multiple MIMO layers.

In NR Rel-16, DCI format 1_2 was introduced for downlink scheduling. One of the main motivations for having the new DCI format is to be able to configure a very small DCI size which can provide some reliability improvement without losing much flexibility. The main design target of the new DCI format is thus to have a DCI with highly configurable sizes for more fields, as compared to DCI format 1_1, with a minimum DCI size targeting a reduction of 10-16 bits relative to Rel-15 DCI format 1_0.

PUCCH Resources

In Rel-15 NR, up to four PUCCH resource sets can be configured to a UE. A PUCCH resource set with pucch-ResourceSetId=0 can have up to 32 PUCCH resources while for PUCCH resource sets with pucch-ResourceSetId=1 to 3, each set can have up to 8 PUCCH resources. A UE determines the PUCCH resource set in a slot based on the number of aggregated Uplink Control Information (UCI) bits to be sent in the slot. The UCI bits consists of Hybrid Automatic Repeat request (HARQ) ACK/NACK, scheduling request (SR), and channel state information (CSI) bits.

For a PUCCH transmission with HARQ-ACK information, a UE determines a PUCCH resource after determining a PUCCH resource set. The PUCCH resource determination is based on a 3-bit PUCCH resource indicator (PRI) field in DCI format 1_0 or DCI format 1_1. In the case of DCI format 1_2, the PUCCH resource determination is based on a configurable PRI field with the field size configurable between 0 and 3 bits.

If more than one DCI formats 1_0, 1_1 or 1_2 are received in the case of Carrier Aggregation (CA) and/or Time Division Duplex (TDD), the PUCCH resource determination is based on a PRI field in the last DCI format 1_0, 1_1 or 1_2 among the multiple received DCI format 1_0, 1_1 or 1_2 that the UE detects. In this case, the multiple received DCI format 1_0, 1_1 or 1_2 have a value of a PDSCH-to-HARQ_feedback timing indicator field indicating the slot (or sub-slot, if configured) for the PUCCH transmission. For PUCCH resource determination in this case, detected DCI formats are first indexed in an ascending order across serving cells indexed for a same PDCCH monitoring occasion and are then indexed in an ascending order across PDCCH monitoring occasion indexes.

Spatial Relation Definition

Spatial relation is used in NR to refer to a relationship between an UL reference signal (RS) such as PUCCH/PUSCH demodulation reference signal (DMRS) and another RS, which can be either a DL RS (e.g. channel state information RS (CSI-RS) or synchronization signal block (SSB)) or an UL RS (e.g. sounding reference signal (SRS)). This is defined from a UE perspective.

If an UL RS is spatially related to a DL RS, it means that the UE should transmit the UL RS in the opposite (reciprocal) direction from which it received the DL RS previously. More precisely, the UE should apply the “same” transmit (Tx) spatial filtering configuration for the transmission of the UL RS as the receive (Rx) spatial filtering configuration it used to receive the spatially related DL RS previously. Here, the terminology ‘spatial filtering configuration’ may refer to the antenna weights that are applied at either the transmitter or the receiver for data/control transmission/reception. The DL RS is also referred to as the spatial filter reference signal.

If a first UL RS is spatially related to a second UL RS, then the UE should apply the same Tx spatial filtering configuration for the transmission of the first UL RS as the Tx spatial filtering configuration it used to transmit the second UL RS.

An example of using spatial relation for PUCCH is shown in FIG. 3. First, the gNB in Transmission and Reception Point (TRP) A indicates to the UE that the PUCCH DMRS is spatially related to the DL RS. Then, the UE receives the DL RS using Rx spatial filtering configuration (i.e., Rx beam) as shown in FIG. 3(a). As shown in FIG. 3(b), the UE uses the same Tx spatial filtering configuration (i.e., Tx beam) as the one it used in FIG. 3(a) to transmit PUCCH.

Spatial Relation Indication for PUCCH

NR Rel-15 Spatial Relation Indication for PUCCH

For NR Rel-15, 3GPP TS 38.213 and 3GPP TS 38.331 specify that a UE can be Radio Resource Control (RRC) configured with a list of up to 8 spatial relations for PUCCH. This list is given by the RRC parameter PUCCH_SpatialRelationInfo. For example, the list would typically contain the identities/identifiers (IDs) of a number of SSBs and/or CSI-RS resources. Alternatively, the list may also contain the IDs of a number of SRS resources.

Based on the DL (or UL) beam management measurements performed by the UE (or gNB), the gNB selects one of the RS IDs from the list of configured ones in PUCCH_SpatialRelationInfo. The selected spatial relation is then activated via a Media Access Control (MAC)-Control Element (CE) message signaled to the UE for a given PUCCH resource. The UE then uses the signaled spatial relation for the purposes of adjusting the Tx spatial filtering configuration for the transmission on that PUCCH resource.

The MAC CE for activation/deactivation for PUCCH spatial relation is shown in FIG. 4, which is extracted from FIG. 6.1.3.18-1 of 3GPP TS 38.321. The MAC-CE message contains (1) the ID of the PUCCH resource, and (2) an indicator of which of the 8 configured spatial relations in PUCCH SpatialRelationInfo is selected (given by the 8 bits S₀, S₁, S₂, . . . , S₇). The MAC CE also includes the Serving Cell ID for which the MAC CE applies, and the bandwidth part ID (BWP ID) which indicates the UL BWP for which the MAC CE applies as the codepoint of the DCI bandwidth part indicator field, as specified in 3GPP TS 38.212.

In addition to providing the spatial relation for PUCCH, each PUCCH_SpatialRelationInfo (as shown below) also provides some PUCCH power control parameters including a Reference RS ID (i.e., pucch-PathlossReferenceRS-Id) for path loss estimation, p0-PUCCH-Id for open loop power control, and closedLoopindex for closed loop power control. The pucch-PathlossReferenceRS can be either an CSI-RS or SSB.

| PUCCH-SpatialRelationInfo : := | SEQUENCE { | |
|---|---|---|
| pucch-SpatialRelationInfoId | PUCCH-SpatialRelationInfoId, | |
| servingCellId | ServCellIndex | |
| OPTIONAL, --- Need S | | |
| referenceSignal | CHOICE { | |
| ssb-Index | SSB-Index, | |
| csi-RS-Index | NZP-CSI-RS-ResourceId, | |
| srs | SEQUENCE { | |
| | resource | SRS- |
| ResourceId, | | |
| | uplinkBWP | BWP-Id |
| | } | |
| }, | | |
| pucch-PatchlossReferencesRS-Id | PUCCH-Pathloss ReferencesRS-Id, | |
| p0-PUCCH-Id | P0-PUCCH-Id, | |
| closedLoopIndex | ENUMERATED { i0, i1 } | |

NR Rel-16 Spatial Relation Indication for PUCCH

One enhancement made in NR Rel-16 is to increase the maximum number of RRC configured spatial relations for PUCCH. As per this enhancement, an NR Rel-16 UE can be RRC configured with a list of up to 64 spatial relations for PUCCH.

For NR Rel-15, the spatial relation is updated per PUCCH resource. In NR Rel-16, to achieve signaling overhead reduction, simultaneous spatial relation update/indication for a group of PUCCH resources is introduced. In Rel-16, explicit higher layer signaling is used to indicate to the UE a group of PUCCH resources, and MAC CE is used to simultaneously update/indicate a single spatial relation per group of PUCCH resources. When the MAC CE simultaneously updates/indicates a single spatial relation for a group of PUCCH resources, the indicated spatial relation is applied to all the PUCCH resources in the group of PUCCH resources. In NR Rel-16, up to 4 PUCCH groups are supported per BWP.

Configuration of PUCCHConfigList in UL Dedicated BWP in Rel-16

The Ultra Reliable and Low Latency Communication (URLLC) Rel-16 Work Item (WI) will introduce a list of PUCCH configurations per UL BWP as can be seen from the running Change Request (CR) excerpt (i.e. R1-1913675, which can be found at https://www.3gpp.org/ftp.tsg_ran/WG2_RL2/TSGR2_109_e/Docs/R2-2001356.zip). Tis results in doubling the PUCCH resources in the UL BWP and also reusing the PUCCH resource IDs. Thus, after adding the PUCCHConfigList, the PUCCH resource ID is not unambiguous in the UL BWP anymore. In the text below, the text in bold represents new additions of Rel-16 and the text underlined shows the PUCCH resource configurations in the PUCCHConfig.

### BWP-UplinkDedicated Information Element (IE)

-- [symbol]
-- TAG-BWP-

[symbol]

| | | |
|---|---|---|
| BWP-UplinkDedicated : := | SEQUENCE { | |
| pucch-Config | | SetupRelease { PUUCH-Config } |
| OPTIONAL, ---- Need [v] | | |
| pusch-Config | | SetupRelease { PUSCH-Config } |
| OPTIONAL, ---- Need [v] | | |
| configuredGrantConfig | | SetupRelease { ConfiguredGrantConfig } |
| OPTIONAL, ---- Need [v] | | |
| srs-Config | SetupRelease { SRS-Config } | OPTIONAL, |
| ---- Need [v] | | |
| beamFailureRecoveryConfig | | SetupRelease { BeamFailureRecoveryConfig } |
| OPTIONAL, ---- Cond SpCellOnly | | |
| ..., | | |
| [[ | | |
| pucch-ConfigurationList-r16 | | SetupRelease { PUCCH-ConfigurationList-r16 } |
| OPTIONAL, ---- Need [v] | | |
| ]] | | |
| } | | |

---- TAG-BWP-UPLINKDEDICATED-STOP
---- [symbol] [symbol]
indicates data missing or illegible when filed

### PUCCH-ConfigurationList Information Element

---- [symbol]
---- TAG-PUCCH-CONFIGURATIONLIST-START
pucch-ConfigurationList-r16 : :=
SEQUENCE (SIZE (1..2)) OF PUCCH-Config
---- TAG-PUCCH-CONFIGURATIONLIST-STOP
----

[symbol]

[symbol]

indicates data missing or illegible when filed

### PUCCH-Config Information Element

---- [symbol]
---- TAG-PUCCH-CONFIG-START

| | |
|---|---|
| OUCCH-Config ::= | SEQUENCE{ |
| resourceSetToAddModList | SEQUENCE (SIZE |
| PUCCH-ResourceSet OPTIONAL, ----Need N | (1..maxNrofPUCCH-ResourceSets)) OF |
| resourceSetToReleaseList | SEQUENCE (SIZE |
| PUCCH-ResourceSetId OPTIONAL, ----Need N | (1..maxNrofPUCCH-ResourceSets)) OF |
| resourceToAddModList | SEQUENCE (SIZE |
| Resource OPTIONAL, ---- Need N | (1..maxNrofPUCCH-Resources)) OF PUCCH- |
| resourceToReleaseList | SEQUENCE (SIZE |
| | (1..maxNrofPUCCH-Resources)) OF PUCCH- |
| ResourceId OPTIONAL, ---- Need N | |
| format1 | SetupRelease { PUCCH-FormatConfig } |
| OPTIONAL, ----Need [v] | |
| format2 | SetupRelease { PUCCH-FormatConfig } |
| OPTIONAL, ----Need [v] | |
| format3 | SetupRelease { PUCCH-FormatConfig } |
| OPTIONAL, ----Need [v] | |
| format4 | SetupRelease { PUCCH-FormatConfig } |
| OPTIONAL, ----Need [v] | |

[symbol]

indicates data missing or illegible when filed

(end of the IE omitted)

### SUMMARY

Currently there exists some challenges. The section entitled “Configuration of PUCCHConfigList in UL dedicated BWP in Rel-16” of the background section means that the current MAC CE in Rel-15, or the PUCCH MAC CEs described in R1-1907966 LS on MIMO enhancement for NR, cannot address the single PUCCH resource unambiguously if PUCCHConfigList is configured as an ID space of PUCCH resource sets and is reused within the BWP.

Further, it has been disclosed that more than one spatial relation can be associated with a PUCCH resource. However, the need to indicate spatial relations for PUCCH resource ID or PUCCH resource ID set or group per PUCCHConfig has not been addressed. The PUCCH resource ID set exists in Rel-15 and additionally in Rel-16, the PUCCH resource group is specified. That is, each PUCCHConfig may have one or two PUCCH groups configured through RRC.

Embodiments of this disclosure address these challenges. For example, the embodiments propose modifying the discussed MAC CEs to include PUCCHConfig ID in order to unambiguously address a PUCCH resource ID when a PUCCHConfig list is configured. Furthermore, the PUCCHConfig ID can unambiguously address a PUCCH resource set or resource group or PUCCH resource configuration group. Additionally, solutions are provided to handle the ID space of PUCCH resource IDs such that unambiguous pointing is possible.

According to one aspect, some embodiments include methods performed by a wireless device. For example, a method for handling spatial relations for PUCCH resources belonging to different PUCCH resource configuration groups (or PUCCH groups) may comprise: receiving, from a network node, a command to activate or deactivate a spatial relation for a PUCCH resource, wherein each PUCCH of the different PUCCH groups is uniquely identified in the command; and performing one of activating and deactivating the spatial relation for the PUCCH resource identified in the command.

According to another aspect, some embodiments include a wireless device configured, or operable, to perform one or more functionalities (e.g. actions, operations, steps, etc.) as described herein.

In some embodiments, the wireless device may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

According to another aspect, some embodiments include methods performed by a network node. For example, a method for indicating spatial relations for PUCCH resources belonging to different PUCCH resource configuration groups (or PUCCH groups) may comprise: determining a PUCCH group to which a PUCCH resource belongs; and sending, to a wireless device, a command to activate or deactivate a spatial relation for the PUCCH resource, wherein each PUCCH resource of the different PUCCH groups is uniquely identified in the command.

According to yet another aspect, some embodiments include a network node configured, or operable, to perform one or more functionalities (e.g. actions, operations, steps, etc.) as described herein.

In some embodiments, the network node may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the network node and the wireless device may comprise one or more functional modules configured to perform one or more functionalities as described herein.

According to yet another aspect, some embodiments include a non-transitory computer-readable medium storing a computer program product comprising instructions which, upon being executed by processing circuitry (e.g., at least one processor) of the network node or wireless device, configure the processing circuitry to perform one or more functionalities as described herein.

The advantages/technical benefits of the embodiments of the present disclosure are to enable PUCCH spatial relation indication when PUCCHConfigList (indicating different PUCCH resource configuration groups) is configured.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 illustrates a NR time-domain structure with 15 kHz subcarrier spacing.

FIG. 2 illustrates a NR physical resource grid.

FIG. 3 illustrates an example of using spatial relation for PUCCH.

FIG. 4 illustrates a PUCCH spatial relation Activation/Deactivation MAC CE (extracted from FIG. 6.1.3.18-1 of 3GPP TS 38.321).

FIG. 5 illustrates an Extended PUCCH spatial relation Activation/Deactivation MAC CE, according to an embodiment.

FIG. 6 illustrates an Extended PUCCH spatial relation Activation/Deactivation MAC CE, according to an embodiment.

FIG. 7 illustrates an Extended PUCCH spatial relation Activation/Deactivation MAC CE, according to an embodiment.

FIG. 8 illustrates a Group-based PUCCH spatial relation Activation/Deactivation MAC CE, according to an embodiment.

FIG. 9 illustrates a PUCCH spatial relation Activation/Deactivation MAC CE, according to an embodiment.

FIG. 10 illustrates a PUCCH spatial relation Activation/Deactivation MAC CE, according to an embodiment.

FIG. 11 illustrates a PUCCH spatial relation Activation/Deactivation MAC CE, according to an embodiment.

FIG. 12 is a flow chart of a method in a wireless device, in accordance with an embodiment.

FIG. 13 is a flow chart of a method in a network node, in accordance with an embodiment.

FIG. 14 illustrates one example of a wireless communications system in which embodiments of the present disclosure may be implemented.

FIGS. 15 and 16 are block diagrams that illustrate a wireless device according to some embodiments of the present disclosure.

FIGS. 17 and 18 are block diagrams that illustrate a network node according to some embodiments of the present disclosure.

FIG. 19 illustrates a virtualized environment of a network node, according to some embodiments of the present disclosure.

FIG. 20 is a flow chart of a method in a wireless device, in accordance with an embodiment.

FIG. 21 is a flow chart of a method in a network node, in accordance with an embodiment.

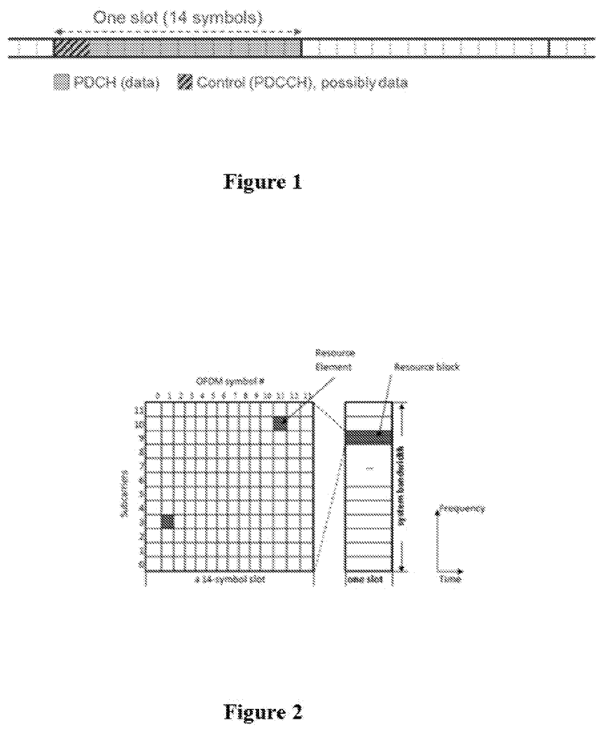

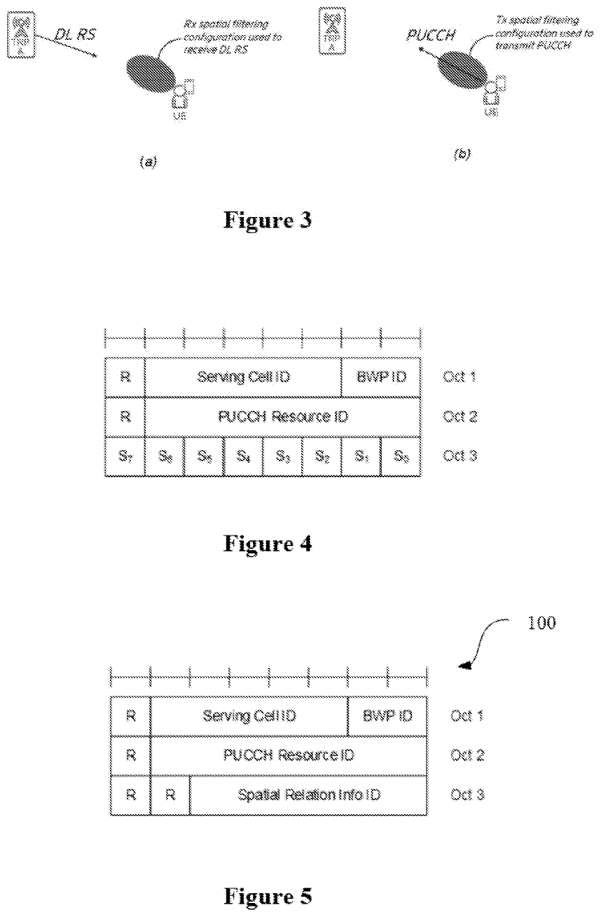

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

In a first example, more than one PUCCHConfigs can be constructed because more than one HARQ-ACK codebooks are applied. For example, when two HARQ-ACK codebooks are simultaneously constructed, PUCCH Config ID=0 (or, alternatively, 1) refers to the PUCCH-Config used by the first HARQ-ACK codebook, and PUCCH Config ID=1 (or, alternatively, 0) refers to the PUCCH-Config used by the second HARQ-ACK codebook.

An issue in this case is that after adding PUCCHConfigList, the ID space is extended and the current way of coding reuses the ID space. Generally stated, in order to solve this issue, an indication, such as the PUCCHConfig ID, is added to the MAC CEs that are being designed in Rel-16. To do so, the PUCCH spatial relation Activation/Deactivation MAC CE is extended. The extended PUCCH spatial relation Activation/Deactivation MAC CE 100 is illustrated in FIG. 5.

The Extended PUCCH spatial relation Activation/Deactivation MAC CE 100 of FIG. 5 is identified by a MAC subheader with Logical Channel ID (LCID) as specified in Table 6.2.1-1 of 3GPP TS 38.321. For example, it has a fixed size of 24 bits with the following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212. The length of the BWP ID field is 2 bits;
PUCCH Resource ID: This field contains an identifier of the PUCCH resource ID identified by PUCCH-ResourceId as specified in TS 38.331. The length of the field is 7 bits;
Spatial Relation Info ID: This field contains an identifier of the PUCCH Spatial Relation Info ID identified by PUCCH-SpatialRelationInfold as specified in TS 38.331. The length of the field is 6 bits;
R: Reserved bit, set to 0.

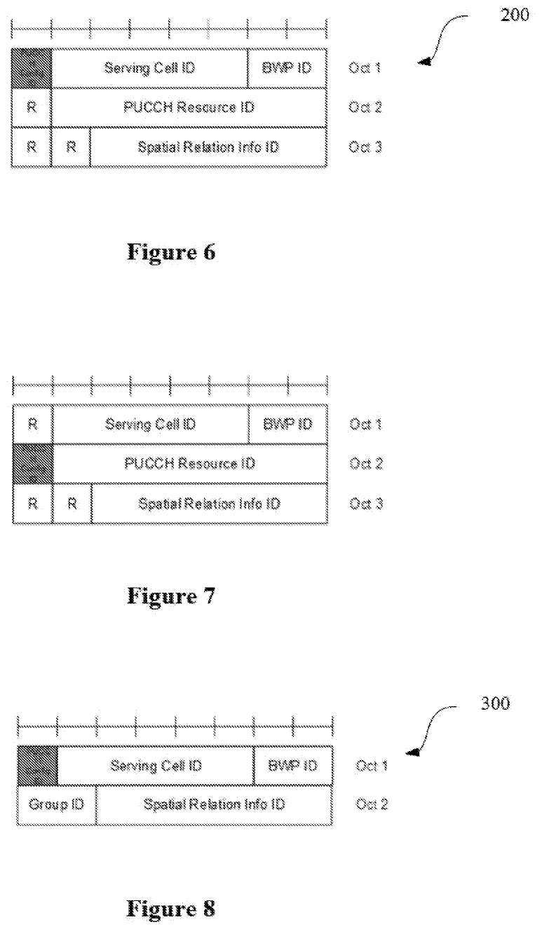

More specifically, the extended PUCCH spatial relation Activation/Deactivation MAC CE 100 can have an indication of PUCCH Configuration ID, as illustrated in FIG. 6. Indeed, FIG. 6 illustrates an extended PUCCH spatial relation Activation/Deactivation MAC CE 200, which has a field to indicate the PUCCH Config ID. The length of the field is 1 bit, taking the value ‘0’ or ‘1’. This field indicates the identity of the PUCCH Configuration in the IE PUCCHConfigList as specified in TS 38.331. If the PUCCHConfigList is not configured, this field is set to 0. For example, the Reserved bit R in Oct 1 can be used to indicate the PUCCH configuration ID. As an alternative and as illustrated in FIG. 7, the Reserved bit in Oct 2 can be used to indicate the PUCCH configuration ID. Furthermore, it is also possible to use one of the two ‘R’ bits in Oct 3 to indicate the PUCCH Configuration ID as well.

It should be noted that the PUCCHConfigList can indicate several or a plurality of PUCCHConfigurations (referred to as PUCCH Configs) or a plurality of PUCCH resource configuration groups. Each PUCCH configuration is identified by a PUCCH Config ID. Each PUCCH configuration may comprise a plurality of PUCCH resources. In this case, the plurality of PUCCH configurations can be indicated by several bits. For example, if there are N PUCCH configs, then log_2(N) bits are needed to indicate the PUCCH configs.

The relevant RRC configurations corresponding to the above example are illustrated below, with the definition in bold:

| | |
|---|---|
| PUCCH-ConfigList | SEQUENCE (SIZE (1..2)) OF PUCCH-Config |
| PUCCH-Config ::= | SEQUENCE { |
| PUCCH-Config-ID | Integer(0..1), |
| resourceSetToAddModList | SEQUENCE (SIZE (1..maxNrofPUCCH-ResourceSets)) OF |
| PUCCH-ResourceSet OPTIONAL, ---- Need N | |
| resourceSetToReleaseList | SEQUENCE (S1ZE (1.. maxNrofPUCCH-ResourceSets)) OF |
| PUCCH-ResourceSetId OPTIONAL, ---- Need N | |
| resourceToAddModList | SEQUENCE (S1ZE (1.. maxNrofPUCCH-ResourceSets)) |
| Resource OPTIONAL, ---- Need N | OF PUCCH- |
| resourceToReleaseList | SEQUENCE (S1ZE (1.. maxNrofPUCCH-ResourceSets)) |
| ResourceId OPTIONAL, ---- Need N | OF PUCCH- |
| Part of the IE omitted | |

Due to the new format of the MAC CE for PUCCH spatial relation Activation/Deactivation, an LCID needs to be allocated to it, separate from the existing LCID for “PUCCH spatial relation Activation/Deactivation”. One example is shown in the table below.

Enhanced Table 6.2.1-1 of 3GPP TS 38.213, Values of LCID for DL-SCH is illustrated below:

| Index | LCID values |
|---|---|
| 0 | CCCH |
| 1-32 | Identity of the logical channel |
| 33-44 | Reserved |
| 45 | Enhanced PUCCH spatial relation |
| | Activation/Deactivation |
| 46 | Enhanced TCI States Activation/ |
| | Deactivation for UE-specific PDSCH |
| 47 | Recommended bit rate |
| 48 | SP ZP CSI-RS Resource Set |
| | Activation/Deactivation |
| 49 | PUCCH spatial relation |
| | Activation/Deactivation |
| 50 | SP SRS Activation/Deactivation |
| 51 | SP CSI reporting on PUCCH |
| | Activation/Deactivation |
| 52 | TCI State Indication for UE-specific PDCCH |
| 53 | TCI States Activation/Deactivation for UE- |
| | specific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

In a second example, a Group-based PUCCH spatial relation Activation/Deactivation MAC CE is considered. FIG. 8 illustrates such a MAC CE 300.

The Group-based PUCCH spatial relation Activation/Deactivation MAC CE 300 is identified by a MAC subheader with LCID as specified in Table 6.2.1-1 of 3GPP TS 38.321. It has a fixed size of 16 bits with the following fields:
PUCCH Config ID: The length of the field is 1 bit, taking the value of ‘0’ or ‘1’. This field indicates the identity of the PUCCH Configuration in IE PUCCHConfigList as specified in TS 38.331. If the PUCCHConfigList is not configured, this field is set to 0.
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212. The length of the BWP ID field is 2 bits;
Group ID: This field contains an identifier of the PUCCH resource group ID identified as specified in TS 38.331. The length of the field is 2 bits; due to the grouping of PUCCH resource set, all the PUCCH resource sets in the same group are applied the same spatial info as identified by “Spatial Relation Info ID.”
Spatial Relation Info ID: This field contains an identifier of the PUCCH Spatial Relation Info ID identified by PUCCH-SpatialRelationInfold as specified in TS 38.331. The length of the field is 6 bits.

In another example, the MAC CEs of the previous examples are combined such that the MAC CE can indicate either single PUCCH resource, or a list of PUCCH resources and/or a group of PUCCH resources.

The relevant RRC configurations corresponding to the PUCCH-Config-ID of the example just above are illustrated below, with the new definitions in bold:

| | |
|---|---|
| PUCCH-Config :: = | SEQUENCE { |
| PUCCH-Config-ID | Integer(0..1), |
| resourceGroup1 | SEQUENCE (SIZE (1..maxNrofPUCCH-ResourcesInGroup)) OF PUCCH- |
| Resource OPTIONAL, ---- Need N | |
| resourceGroup2 | SEQUENCE (SIZE (1..maxNrofPUCCH-ResourcesInGroup)) OF PUCCH- |
| ResourceS OPTIONAL, ---- Need N | |
| resourceGroup3 | SEQUENCE (SIZE (1..maxNrofPUCCH-ResourcesInGroup)) OF PUCCH- |
| Resource OPTIONAL, ---- Need N | |
| Rest of the IE omitted | |

In one example, the grouping of the PUCCH resources is extended from only the PUCCH resource ID to both the PUCCH resource ID and PUCCH config ID. For example, the grouping of PUCCH resource was (PUCCH resource 1, PUCCH resource 2) and now the grouping is extended to be (PUCCH resource 1-PUCCH Config 1, PUCCH resource 1-PUCCH Config 2, PUCCH Resource 2-PUCCH Config 1, PUCCH Resource 2-PUCCH Config 2).

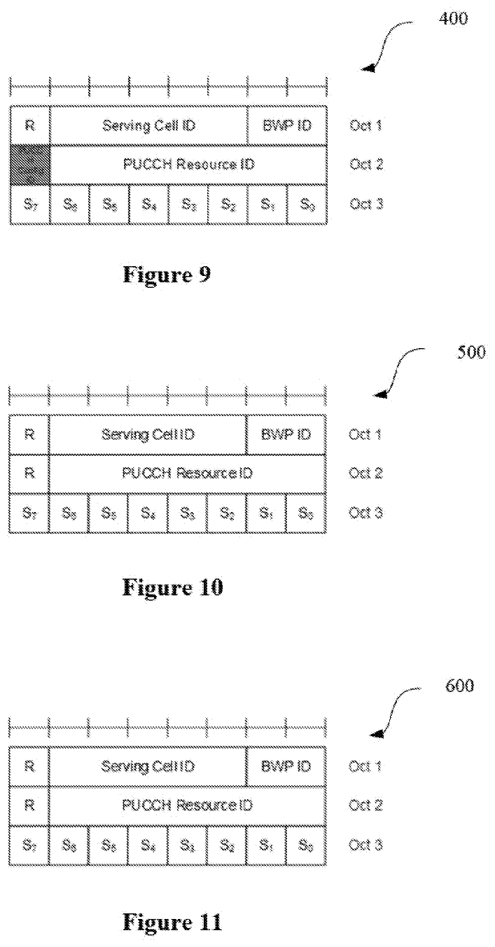

In a third example, the Rel-15 MAC CE format is kept, however, one reserved bit is used to indicate the PUCCH Config ID. FIG. 9 illustrates such a PUCCH spatial relation Activation/Deactivation MAC CE 400.

The PUCCH spatial relation Activation/Deactivation MAC CE 400 is identified by a MAC subheader with LCID as specified in Table 6.2.1-1 of 3GPP 38.321. It has a fixed size of 24 bits with the following fields:
PUCCH Config ID: This field indicates the identity of the PUCCHConfiguration in IE PUCCHConfigList as specified in TS 38.331. If the PUCCHConfigList is not configured, this field is set to 0.
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212. The length of the BWP ID field is 2 bits;
PUCCH Resource ID: This field contains an identifier of the PUCCH resource ID identified by PUCCH-ResourceId as specified in TS 38.331. The length of the field is 7 bits;
Sᵢ: If there is a PUCCH Spatial Relation Info PUCCH-SpatialRelationInfold as specified in TS 38.331, configured for the uplink bandwidth part indicated by BWP ID field and for the PUCCH Configuration indicated by PUCCH-ConfigID (if PUCCHConfigList is configured), Sᵢ indicates the activation status of PUCCH Spatial Relation Info with PUCCH-SpatialRelationInfold equal to i+1, otherwise MAC entity shall ignore this field. The Sᵢ field is set to 1 to indicate PUCCH Spatial Relation Info with PUCCH-SpatialRelationInfold equal to i+1 shall be activated. The Sᵢ field is set to 0 to indicate PUCCH Spatial Relation Info with PUCCH-SpatialRelationInfold equal to i+1 shall be deactivated. Only a single PUCCH Spatial Relation Info can be active for a PUCCH resource at a time. The reserved bit in Oct 1 or Oct 2 can be used to indicate the PUCCH Config ID.

In a fourth example, the Rel-15 MAC CE format is kept, however, there is an implicit grouping of the same PUCCH resource ID from two different PUCCH configurations, as such the different PUCCH configurations are indirectly indicated. FIG. 10 illustrates such as case.

The PUCCH spatial relation Activation/Deactivation MAC CE 500 is identified by a MAC subheader with LCID as specified in Table 6.2.1-1 of 3GPP 38.321. It has a fixed size of 24 bits with the following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212. The length of the BWP ID field is 2 bits;
PUCCH Resource ID: This field contains an identifier of the PUCCH resource ID identified by PUCCH-ResourceId as specified in TS 38.331. The length of the field is 7 bits;
Sᵢ: If there is a PUCCH Spatial Relation Info PUCCH-SpatialRelationInfold as specified in TS 38.331, configured for the uplink bandwidth part indicated by BWP ID field, Sᵢ indicates the activation status of PUCCH Spatial Relation Info with PUCCH-SpatialRelationInfold equal to i+1, otherwise MAC entity shall ignore this field. The Sᵢ field is set to 1 to indicate PUCCH Spatial Relation Info with PUCCH-SpatialRelationInfold equal to i+1 shall be activated. The Sᵢ field is set to 0 to indicate PUCCH Spatial Relation Info with PUCCH-SpatialRelationInfold equal to i+1 shall be deactivated. Only a single PUCCH Spatial Relation Info can be active for a PUCCH Resource at a time. This applies to all PUCCH configurations with the associated PUCCH-SpatialRelationInfold;
R: Reserved bit, set to 0.

In another example, the Rel-15 MAC CE format is kept, or the Rel-16 MAC CE format is kept (e.g. without the PUCCHConfig ID addition), however, an implicit indication of the PUCCH configuration ID a PUCCH resource belongs to can be provided. For example, the two lists of PUCCH resources in each PUCCH-config can be concatenated and numbered starting with the first element of the list of PUCCH resources in the first PUCCH configuration. Following the last element of the list of PUCCH resources in the first PUCCH configuration comes the first element of the list of PUCCH resources in the second PUCCH configuration. The last element of the concatenated list is the last element of the list of PUCCH resources in the second PUCCH configuration.

As each PUCCH resource can be uniquely indicated by the MAC CE, the PUCCH resource implicitly indicates the PUCCH configuration group to which it belongs. FIG. 11 illustrates this example, for the Rel-15 MAC CE and the Rel-16 MAC CEs (which are under discussion in 3GPP).

The PUCCH spatial relation Activation/Deactivation MAC CE 600 is identified by a MAC subheader with LCID as specified in Table 6.2.1-1 of 3GPP 38.321. It has a fixed size of 24 bits with following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212. The length of the BWP ID field is 2 bits;
PUCCH Resource ID: This field is an index into the list of PUCCH resources, consisting of the resourceToAddModList of the first pucch-config followed by the resourceToAddModList of the second pucch-config as specified in TS 38.331. The length of the field is 7 bits;
Sᵢ: If there is a PUCCH Spatial Relation Info PUCCH-SpatialRelationInfold as specified in TS 38.331, configured for the uplink bandwidth part indicated by BWP ID field, Sᵢ indicates the activation status of PUCCH Spatial Relation Info with PUCCH-SpatialRelationInfold equal to i+1, otherwise MAC entity shall ignore this field. The Sᵢ field is set to 1 to indicate PUCCH Spatial Relation Info with PUCCH-SpatialRelationInfold equal to i+1 shall be activated. The Sᵢ field is set to 0 to indicate PUCCH Spatial Relation Info with PUCCH-SpatialRelationInfold equal to i+1 shall be deactivated. Only a single PUCCH Spatial Relation Info can be active for a PUCCH Resource at a time.
R: Reserved bit, set to 0

In the disclosure above, a MAC CE has been used to indicate the PUCCH Config ID. It should be noted that the present teachings are not limited to a MAC CE and may apply to other messages as well, as will be appreciated by a person skilled in the art.

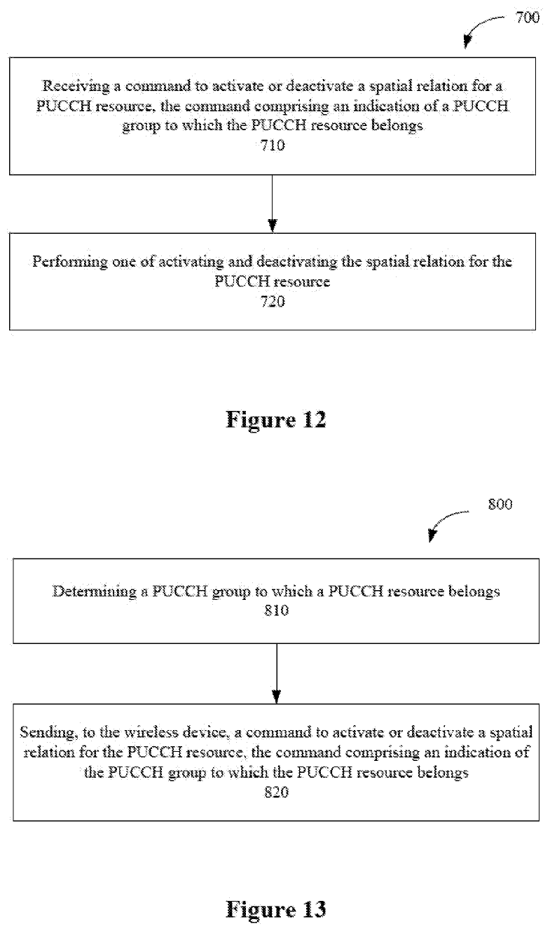

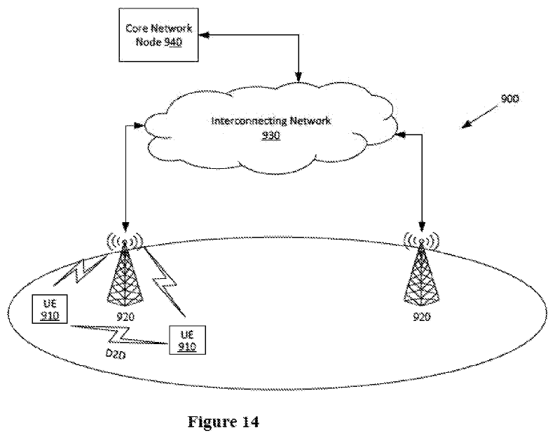

Now turning to FIG. 12, a flow chart of a method 700 for handling spatial relations for a PUCCH resource, by a user equipment (UE)/wireless device for which a plurality of PUCCH configurations are provided, will be described. The PUCCH configurations may comprise several lists or groups of PUCCH resources. The method may be implemented in a wireless device such as 910 of FIG. 14. Method 700 comprises the following steps:

Step 710: receiving, from a network node, a command to activate or deactivate a spatial relation for a PUCCH resource, the command comprising an indication of a PUCCH group to which the PUCCH resource belongs;

Step 720: performing one of activating and deactivating the spatial relation for the PUCCH resource.

FIG. 13 illustrates a flow chart of a method 800 for indicating spatial relations for a PUCCH resource to a UE/wireless device. The wireless device and/or the network node may be configured with a plurality of PUCCH configurations (or PUCCH resource configuration groups). The PUCCH configurations may comprise several lists or groups of PUCCH resources. Method 800 can be implemented in a network node, such as 920 of FIG. 14. Method 800 may comprise:

Step 810: determining a PUCCH group to which a PUCCH resource belongs.

Step 820: sending, to the wireless device, a command to activate or deactivate a spatial relation for the PUCCH resource, the command comprising an indication of the PUCCH group to which the PUCCH resource belongs.

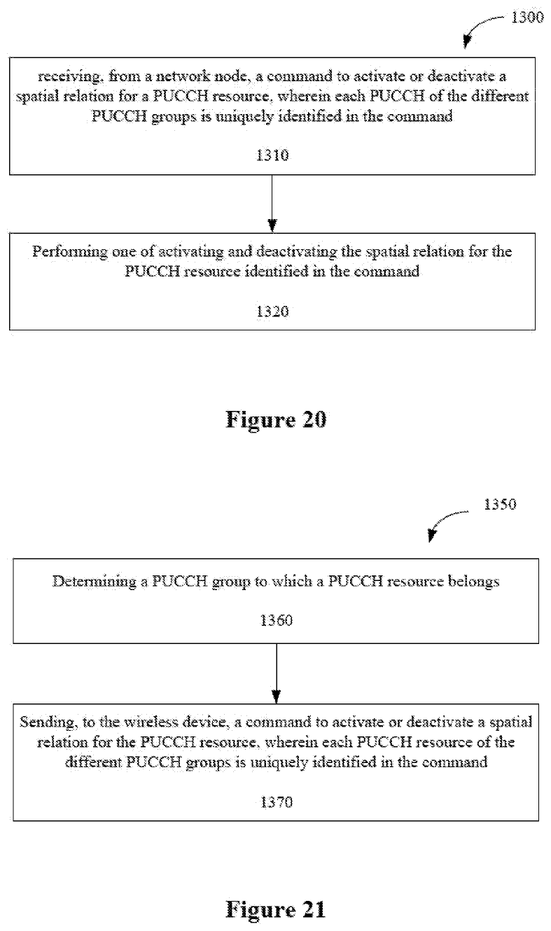

Turning to FIG. 20 now, a method 1300 in a wireless device, for handling spatial relations for Physical Uplink Control Channel (PUCCH) resources belonging to different PUCCH groups (or PUCCH resource configuration groups) will be described. The method 1300 comprises:

Step 1310: receiving, from a network node, a command to activate or deactivate a spatial relation for a PUCCH resource, wherein each PUCCH of the different PUCCH groups is uniquely identified in the command; and

Step 1320: performing one of activating and deactivating a spatial relation for the PUCCH resource identified in the command.

In some examples, the method may receive a Medium Access Control (MAC) Control Element (CE), such as an enhanced 3GPP TS 38.321 Release 15 MAC CE or a Release 16 MAC CE.

In some examples, the PUCCH resources of a first PUCCH group can be concatenated with PUCCH resources of a second PUCCH group.

In some examples, each PUCCH resource can be uniquely identified by using a PUCCH resource Identifier (ID) and a PUCCH group ID. For example, the PUCCH group ID can be a PUCCH Config ID.

In some examples, each PUCCH resource can be uniquely identified by using a PUCCH resource Identifier (ID) that is different for each PUCCH group. For example, the PUCCH resources for the different PUCCH groups can be concatenated. However, the PUCCH resources don't have to be in order, since they are uniquely identified.

In some examples, the command can comprise a PUCCH spatial relation for a plurality of PUCCH resources. For example, the plurality of PUCCH resources can belong to different PUCCH groups (or PUCCH resource configuration groups).

In some examples, the command may comprise a group ID, the group ID identifying the plurality of PUCCH resources to which the same PUCCH spatial relation is applied.

Now, turning to FIG. 21, a method 1350 in a network node, for handling spatial relations for Physical Uplink Control Channel (PUCCH) resources belonging to different PUCCH groups (or PUCCH resource configuration groups) will be described. The method 1350 comprises:

Step 1360: determining a PUCCH group to which a PUCCH resource belongs.

Step 1370: sending, to the wireless device, a command to activate or deactivate a spatial relation for the PUCCH resource, wherein each PUCCH resource of the different PUCCH groups is uniquely identified in the command.

In some examples, the method may send a Medium Access Control (MAC) Control Element (CE), such as an enhanced 3GPP TS 38.321 Release 15 MAC CE or a Release 16 MAC CE.

In some examples, the PUCCH resources of a first PUCCH group can be concatenated with PUCCH resources of a second PUCCH group.

In some examples, each PUCCH resource can be uniquely identified by using a PUCCH resource Identifier (ID) and a PUCCH group ID. For example, the PUCCH group ID can be a PUCCH Config ID.

In some examples, each PUCCH resource can be uniquely identified by using a PUCCH resource Identifier (ID) that is different for each PUCCH group. For example, the PUCCH resources for the different PUCCH groups can be concatenated. However, the PUCCH resources don't have to be in order, since they are uniquely identified.

In some examples, the command can comprise a PUCCH spatial relation for a plurality of PUCCH resources.

In some examples, the plurality of PUCCH resources can belong to different PUCCH groups.

In some examples, the command can comprise a group ID, the group ID identifying the plurality of PUCCH resources to which the same PUCCH spatial relation is applied.

FIG. 14 illustrates an example of a wireless network 900 that may be used for wireless communications. Wireless network 900 includes UEs 910 and a plurality of radio network nodes 920 (e.g., Node Bs (NBs) Radio Network Controllers (RNCs), evolved NBs (eNBs), next generation NB (gNBs), etc.) directly or indirectly connected to a core network 930 which may comprise various core network nodes. The network 900 may use any suitable radio access network (RAN) deployment scenarios, including Universal Mobile Telecommunication System (UMTS) Terrestrial Radio Access Network (UTRAN), and Evolved UMTS Terrestrial Radio Access Network (EUTRAN). UEs 910 may be capable of communicating directly with radio network nodes 920 over a wireless interface. In certain embodiments, UEs may also be capable of communicating with each other via device-to-device (D2D) communication. In certain embodiments, network nodes 920 may also be capable of communicating with each other, e.g. via an interface (e.g. X2 in LTE or other suitable interface).

As an example, UE 910 may communicate with radio network node 920 over a wireless interface. That is, UE 910 may transmit wireless signals to and/or receive wireless signals from radio network node 920. The wireless signals may contain voice traffic, data traffic, control signals, and/or any other suitable information. In some embodiments, an area of wireless signal coverage associated with a radio network node 920 may be referred to as a cell.

It should be noted that a UE may be a wireless device, a radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), Universal Serial Bus (USB) dongles, Customer Premises Equipment (CPE) etc.

In some embodiments, the “network node” can be any kind of network node which may comprise of a radio network node such as a radio access node (which can include a base station, radio base station, base transceiver station, base station controller, network controller, gNB, NR BS, evolved Node B (eNB), Node B, Multi-cell/multicast Coordination Entity (MCE), relay node, access point, radio access point, Remote Radio Unit (RRU), Remote Radio Head (RRH), a multi-standard BS (also known as MSR BS), etc.), a core network node (e.g., MME, SON node, a coordinating node, positioning node, MDT node, etc.), or even an external node (e.g., 3rd party node, a node external to the current network), etc. The network node may also comprise a test equipment.

In certain embodiments, network nodes 920 may interface with a radio network controller (not shown). The radio network controller may control network nodes 920 and may provide certain radio resource management functions, mobility management functions, and/or other suitable functions. In certain embodiments, the functions of the radio network controller may be included in the network node 920. The radio network controller may interface with the core network node 940. In certain embodiments, the radio network controller may interface with the core network node 940 via the interconnecting network 930.

The interconnecting network 930 may refer to any interconnecting system capable of transmitting audio, video, signals, data, messages, or any combination of the preceding. The interconnecting network 930 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the core network node 940 may manage the establishment of communication sessions and various other functionalities for wireless devices 910. Examples of core network node 940 may include MSC, MME, SGW, PGW, O&M, OSS, SON, positioning node (e.g. E-SMLC), MDT node, etc. Wireless devices 110 may exchange certain signals with the core network node 940 using the non-access stratum layer. In non-access stratum signaling, signals between wireless devices 910 and the core network node 940 may be transparently passed through the radio access network. In certain embodiments, network nodes 920 may interface with one or more other network nodes over an internode interface. For example, network nodes 920 may interface each other over an X2 interface.

Although FIG. 14 illustrates a particular arrangement of network 900, the present disclosure contemplates that the various embodiments described herein may be applied to a variety of networks having any suitable configuration. For example, network 900 may include any suitable number of wireless devices 910 and network nodes 920, as well as any additional elements suitable to support communication between wireless devices or between a wireless device and another communication device (such as a landline telephone). The embodiments may be implemented in any appropriate type of telecommunication system supporting any suitable communication standards and using any suitable components and are applicable to any radio access technology (RAT) or multi-RAT systems in which the wireless device receives and/or transmits signals (e.g., data). While certain embodiments are described for NR and/or LTE, the embodiments may be applicable to any RAT, such as UTRA, E-UTRA, narrow band internet of things (NB-IoT), WiFi, Bluetooth, next generation RAT (NR, NX), 4G, 5G, LTE FDD/TDD, etc. Furthermore, the communication system 900 may itself be connected to a host computer (see FIG. 20 for example). The network 900 (with the wireless devices 910 and network nodes 920) may be able to operate in LAA or unlicensed spectrum.

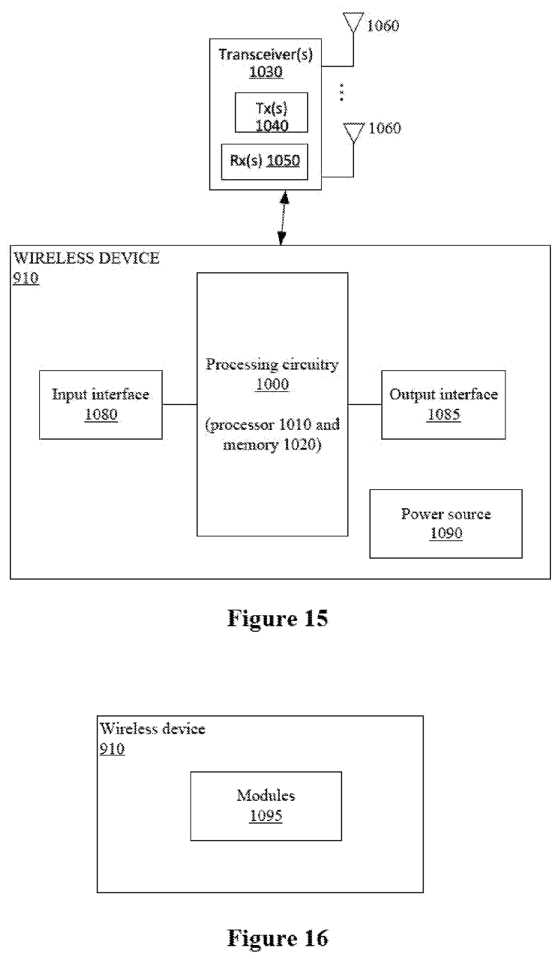

FIG. 15 is a schematic block diagram of the wireless device 910 according to some embodiments of the present disclosure. As illustrated, the wireless device 910 includes circuitry 1000 comprising one or more processors 1010 (e.g., Central Processing Units (CPUs), Application Specific Integrated Circuits (ASICs), Field Programmable Gate Arrays (FPGAs), and/or the like) and memory 1020. The wireless device 910 also includes one or more transceivers 1030 each including one or more transmitters 1040 and one or more receivers 1050 coupled to one or more antennas 1060. Furthermore, the processing circuitry 1000 may be connected to an input interface 1080 and an output interface 1085. The input interface 1080 and the output interface 1085 may be referred to as communication interfaces. The wireless device 910 may further comprise power source 1090.

In some embodiments, the functionality of the wireless device 910 described above may be fully or partially implemented in software that is, e.g., stored in the memory 1020 and executed by the processor(s) 1010. For example, the processor 1010 is configured to perform method 700 of FIG. 12 and method 1300 of FIG. 20.

In some embodiments, a computer program including instructions which, when executed by the at least one processor 1010, causes the at least one processor 1010 to carry out the functionality of the wireless device 910 according to any of the embodiments described herein is provided (e.g. method 700 of FIG. 12 and method 1300 of FIG. 20). In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the wireless device 910 according to some other embodiments of the present disclosure. The wireless device 910 includes one or more modules 1095, each of which is implemented in software. The module(s) 1095 provide the functionality of the wireless device 910 described herein. The module(s) 1095 may comprise, for example, a receiving module operable to perform step 710 of FIG. 12 and step 1310 of FIG. 20. The module(s) 1095 may further comprise an activating/deactivating module operable to perform step 720 of FIG. 12 and step 1320 of FIG. 20.

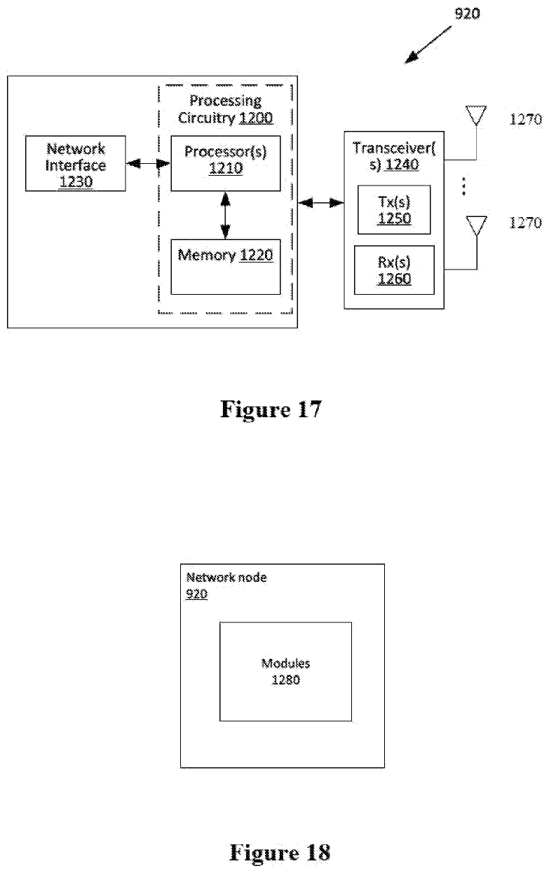

FIG. 17 is a schematic block diagram of a network node 920 according to some embodiments of the present disclosure. As illustrated, the network node 920 includes a processing circuitry 1100 comprising one or more processors 1110 (e.g., CPUs, ASICs, FPGAs, and/or the like) and memory 1120. The network node also comprises a network interface 1130. The network node 920 also includes one or more transceivers 1140 that each include one or more transmitters 1150 and one or more receivers 1160 coupled to one or more antennas 1170. In some embodiments, the functionality of the network node 920 described above may be fully or partially implemented in software that is, e.g., stored in the memory 1120 and executed by the processor(s) 1110. For example, the processor 1110 can be configured to perform any steps of the method 800 of FIG. 13 and method 1350 of FIG. 21.

FIG. 18 is a schematic block diagram of the network node 920 according to some other embodiments of the present disclosure. The network node 920 includes one or more modules 1180, each of which is implemented in software. The module(s) 1180 provide the functionality of the network node 920 described herein. The module(s) 1180 may comprise, for example, a determining module operable to perform step 810 of FIG. 13 and step 1360 of FIG. 21, and a sending module operable to perform step 820 of FIG. 13 and step 1370 of FIG. 21.

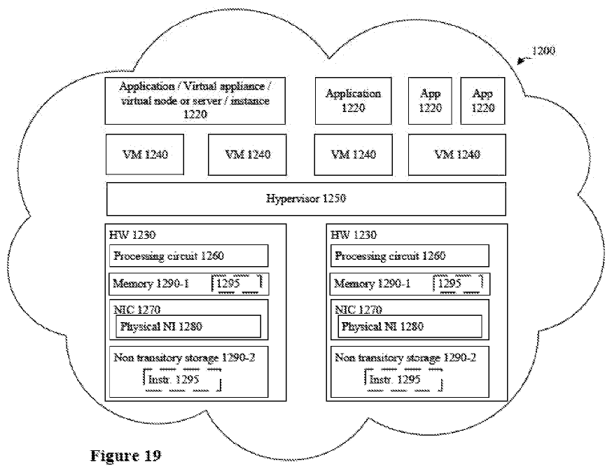

FIG. 19 is a schematic block diagram that illustrates a virtualized embodiment of the wireless device 910 or network node 920, according to some embodiments of the present disclosure. As used herein, a “virtualized” node 1200 is a network node 920 or wireless device 910 in which at least a portion of the functionality of the network node 920 or wireless device 910 is implemented as a virtual component (e.g., via a virtual machine(s) executing on a physical processing node(s) in a network(s)). For example, in FIG. 19, there is provided an instance or a virtual appliance 1220 implementing the methods or parts of the methods of some embodiments. The one or more instance(s) runs in a cloud computing environment 1200. The cloud computing environment provides processing circuits 1230 and memory 1290-1 for the one or more instance(s) or virtual applications 1220. The memory 1290-1 contains instructions 1295 executable by the processing circuit 1260 whereby the instance 1220 is operative to execute the methods or part of the methods described herein in relation to some embodiments.

The cloud computing environment 1200 comprises one or more general-purpose network devices including hardware 1230 comprising a set of one or more processor(s) or processing circuits 1260, which may be commercial off-the-shelf (COTS) processors, dedicated Application Specific Integrated Circuits (ASICs), or any other type of processing circuit including digital or analog hardware components or special purpose processors, and network interface controller(s) (NICs) 1270, also known as network interface cards, which include physical Network Interface 1280. The general-purpose network device also includes non-transitory machine readable storage media 1290-2 having stored therein software and/or instructions 1295 executable by the processor 1260. During operation, the processor(s)/processing circuits 1260 execute the software/instructions 1295 to instantiate a hypervisor 1250, sometimes referred to as a virtual machine monitor (VMM), and one or more virtual machines 1240 that are run by the hypervisor 1250.

A virtual machine 1240 is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 1240, and that part of the hardware 1230 that executes that virtual machine 1240, be it hardware 1230 dedicated to that virtual machine 1240 and/or time slices of hardware 1230 temporally shared by that virtual machine 1240 with others of the virtual machine(s) 1240, forms a separate virtual network element(s) (VNE).

The hypervisor 1250 may present a virtual operating platform that appears like networking hardware to virtual machine 1240, and the virtual machine 1240 may be used to implement functionality such as control communication and configuration module(s) and forwarding table(s), this virtualization of the hardware is sometimes referred to as network function virtualization (NFV). Thus, NFV may be used to consolidate many network equipment types onto industry standard high volume server hardware, physical switches, and physical storage, which can be located in Data centers, and customer premise equipment (CPE). Different embodiments of the instance or virtual application 1220 may be implemented on one or more of the virtual machine(s) 1240, and the implementations may be made differently.

In some embodiments, a carrier comprising the aforementioned computer program product is provided. The carrier can be a computer readable storage medium (e.g., a non-transitory computer readable medium such as memory).

Some embodiments may be represented as a non-transitory software product stored in a machine-readable medium (also referred to as a computer-readable medium, a processor-readable medium, or a computer usable medium having a computer readable program code embodied therein). The machine-readable medium may be a compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description, which is defined solely by the appended claims.

1. A method in a wireless device, for handling spatial relations for Physical Uplink Control Channel (PUCCH) resources belonging to different PUCCH configuration groups, the method comprising:
receiving, from a network node, a command to activate or deactivate a spatial relation from a set of spatial relations, for a PUCCH resource indicated by a PUCCH resource Identifier (ID), wherein each PUCCH resource in the different PUCCH configuration groups is uniquely identified in the command, by using a PUCCH resource ID that is different for each PUCCH configuration group; and
performing one of activating and deactivating the spatial relation for the PUCCH resource indicated in the command.

2. The method of claim 1, wherein receiving the command comprises receiving a Medium Access Control (MAC) Control Element (CE).

3. The method of claim 1, wherein PUCCH resources of a first PUCCH configuration group is concatenated with PUCCH resources of a second PUCCH configuration group.

4. The method of claim 1, wherein the command comprises a PUCCH spatial relation for a plurality of PUCCH resources.

5. The method of claim 4, wherein the plurality of PUCCH resources belong to different PUCCH configuration groups.

6. The method of claim 4, wherein the command comprises a group ID, the group ID identifying the plurality of PUCCH resources to which the same PUCCH spatial relation is applied.

7. The method of claim 1, wherein each PUCCH resource ID indicates a PUCCH configuration group to which the PUCCH resource belongs to.

8. The method of claim 1, wherein the set of spatial relations is associated with a PUCCH configuration group.

9. The method of claim 1, wherein the set of spatial relations is associated with a PUCCH configuration group to which the indicated PUCCH resource ID belongs.

10. (canceled)

11. (canceled)

12. A user equipment (UE) configured to communicate with a base station, the UE comprising a radio interface and processing circuitry configured to:
receive, from a network node, a command to activate or deactivate a spatial relation from a set of spatial relations, for a PUCCH resource indicated by a PUCCH resource Identifier (ID), wherein each PUCCH resource in the different PUCCH configuration groups is uniquely identified in the command, by using a PUCCH resource ID that is different for each PUCCH configuration group; and
perform one of activating and deactivating the spatial relation for the PUCCH resource indicated in the command.

13. A method in a network node, for indicating spatial relations for Physical control channel (PUCCH) resources belonging to different PUCCH configuration groups to a wireless device, the method comprising:
determining a PUCCH configuration group to which a PUCCH resource belongs; and
sending, to the wireless device, a command to activate or deactivate a spatial relation from a set of spatial relations for the PUCCH resource, indicated by a PUCCH resource Identifier (ID), wherein each PUCCH resource in the different PUCCH configuration groups is uniquely identified in the command, by using a PUCCH resource ID that is different for each PUCCH configuration group.

14. The method of claim 13, wherein sending the command comprises sending a Medium Access Control (MAC) Control Element (CE).

15. The method of claim 13, wherein PUCCH resources of a first PUCCH configuration group is concatenated with PUCCH resources of a second PUCCH configuration group.

16. The method of claim 13, wherein the command comprises a PUCCH spatial relation for a plurality of PUCCH resources.

17. The method of claim 16, wherein the plurality of PUCCH resources belong to different PUCCH configuration groups.

18. The method of claim 16, wherein the command comprises a group ID, the group ID identifying the plurality of PUCCH resources to which the same PUCCH spatial relation is applied.

19. The method of claim 13, wherein each PUCCH resource ID indicates a PUCCH configuration group to which the PUCCH resource belongs to.

20. The method of claim 13, wherein the set of spatial relations is associated with a PUCCH configuration group.

21. The method of claim 13, wherein the set of spatial relations is associated with a PUCCH configuration group to which the indicated PUCCH resource ID belongs.

22. (canceled)

23. (canceled)
